(19) United States
(12) Patent Application Publication
(10) Pub. No.: US 2002/0080533 A1
(43) Pub. Date: Jun. 27, 2002

(54) MAGNETO-RESISTANCE EFFECT TYPE MAGNETIC HEAD AND MAGNETIC SIGNAL REPRODUCING APPARATUS

(76) Inventors: TADASHI OZUE, KANAGAWA (JP); TOSHIO SHIRAI, KANAGAWA (JP); YOSHITERU KAMATANI, KANAGAWA (JP); NOBUYUKI NAGAI, KANAGAWA (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/328,410

(22) Filed: Jun. 9, 1999

(30) Foreign Application Priority Data
Jun. 12, 1998 (JP) P10-164878

(51) Int. Cl. G11B 5/39; G11B 5/127

(52) U.S. Cl. 360/313; 360/319; 360/122

(57) ABSTRACT

When a magneto-resistance effect type magnetic head is used as a magnetic tape reproducing head, a contact noise which occurs when a magnetic tape contacts with a magneto-resistance effect element poses a problem. The invention provides a magneto-resistance effect type magnetic head which hardly causes such contact noise and a magnetic signal reproducing apparatus comprising such magneto-resistance effect type magnetic head. A part where a magneto-resistance effect element is formed in a magnetic tape sliding face of the magneto-resistance effect type magnetic head is formed to be a concave of 3 to 30 nm in depth. The contact noise hardly occurs even when the magnetic tape is slid by forming the part where the magneto-resistance effect element is formed into the concave. Still more, almost no output drops due to a spacing loss and a fully large reproduced output may be obtained by defining the depth t1 of the concave within a range of 3 to 30 nm.

### BACKGROUND OF THE INVENTION

1. Field of the Invention

The present invention relates to a magneto-resistance effect type magnetic head comprising a magneto-resistance effect element as a magneto-sensitive element for detecting signals recorded in a magnetic tape and to a magnetic signal reproducing apparatus for reproducing the signals recorded in the magnetic tape by the magneto-resistance effect type magnetic head.

2. Description of the Related Art

A magneto-resistance effect element is a device whose resistance changes depending on the magnitude of an external magnetic field. A magneto-resistance effect type magnetic head comprising the magneto-resistance effect element as a magneto-sensitive element detects magnetic signals from a magnetic recording medium by detecting the changes of the resistance of the magneto-resistance effect element normally by supplying a fixed sense current to the magneto-resistance effect element and by detecting the fluctuation of voltage of the sense current.

Such a magneto-resistance effect type magnetic head produces a large reproduced output and is suited for highly densified recording. Then, the magneto-resistance effect type magnetic head has come to be used widely in a hard disk unit having a high recording density. It is noted that the magneto-resistance effect type magnetic head reproduces signals while floating minutely on the hard disk rotating at high speed in the hard disk unit.

Because the magneto-resistance effect type magnetic head produces the large reproduced output and is suited for the highly densified recording, it is desired to be applied to a magnetic signal reproducing apparatus using a magnetic tape as a recording medium.

However, differing from the hard disk unit, it is not easy to apply the magneto-resistance effect type magnetic head to the magnetic signal reproducing apparatus using the magnetic tape as a recording medium because the magnetic head is supposed to reproduce signals while sliding along the magnetic tape in reproducing the signals.

For instance, when the magneto-resistance effect element which is mounted in the magneto-resistance effect type magnetic head contacts with the magnetic tape, heat is generated by the contact and the heat causes noises in the signals from the magneto-resistance effect element. Further, when a magnetic layer of the magnetic tape is made from a metallic magnetic material having electrical conductivity, the sense current supplied to the magneto-resistance effect element flows also to the magnetic layer when the magneto-resistance effect element contacts with the magnetic tape and noises appear in the signals from the magneto-resistance effect element. It is noted that the noise generated when the magneto-resistance effect element contacts with the magnetic tape will be called a contact noise in the following description.

### SUMMARY OF THE INVENTION

The present invention has been proposed in view of such problems of the past described above and its object is to provide a magneto-resistance effect type magnetic head which hardly generates contact noises even if the magnetic tape is slid along the head and which allows a fully large reproduced output to be obtained and to provide a magnetic signal reproducing apparatus comprising such magneto-resistance effect type magnetic head.

A magneto-resistance effect type magnetic head of the invention comprises a magneto-resistance effect element as a magneto-sensitive element for detecting magnetic signals; a pair of shields sandwiching the magneto-resistance effect element; and an insulating layer disposed between the magneto-resistance effect element and the pair of shields; and is characterized in that the magneto-resistance effect element, the insulating layer and the pair of shields have a magnetic medium sliding face and a part between the pair of shields where the magneto-resistance effect element is created in the magnetic medium sliding face is formed to be a concave whose depth is 3 to 30 nm.

Further, a magnetic signal reproducing apparatus of the invention has a magneto-resistance effect type magnetic head comprising a magneto-resistance effect element as a magneto-sensitive element for detecting magnetic signals; a pair of shields sandwiching the magneto-resistance effect element; and an insulating layer disposed between the magneto-resistance effect element and the pair of shields; and being characterized in that the magneto-resistance effect element, the insulating layer and the pair of shields have a magnetic medium sliding face and a part between the pair of shields where the magneto-resistance effect element is created in the magnetic medium sliding face is formed to be a concave whose depth is 3 to 30 nm.

The inventive magneto-resistance effect type magnetic head and the magneto-resistance effect type magnetic head mounted in the inventive magnetic signal reproducing apparatus hardly cause contact noises even if the magnetic tape is slid along the head because the part between the pair of shields where the magneto-resistance effect element is created is formed into the concave shape. It is also possible to obtain a fully large reproduced output by suppressing the drop of output which is otherwise caused by a spacing loss by defining the depth of the concave within a range of 3 to 30 nm.

The specific nature of the invention, as well as other objects, uses and advantages thereof, will clearly appear from the following description and from the accompanying drawings in which like numerals refers to like parts.

### BRIEF DESCRIPTION OF THE DRAWINGS

FIG. 1 is a perspective view showing an outline of one structural example of a rotary drum unit mounted in a magnetic signal reproducing apparatus to which the invention is applied;

FIG. 2 is a plan view showing an outline of one structural example of a magnetic tape feed mechanism including the rotary drum unit;

FIG. 3 is a section view showing the internal structure of the rotary drum unit;

FIG. 4 is a diagram showing an outline of the circuit structure of the rotary drum unit and its peripheral circuit;

FIG. 5 is a perspective view showing the schematic structure of a magneto-resistance effect type magnetic head mounted in the rotary drum;

FIG. 6 is a plan view when the magneto-resistance effect type magnetic head is seen from the side of the magnetic tape sliding face thereof;

FIG. 7 is a section view taken along a line X1-X2 in FIG. 6 and showing the main part of the magneto-resistance effect type magnetic head;

FIG. 8 is a section view taken along a line X3-X4 in FIG. 6 and showing the main part of the magneto-resistance effect type magnetic head;

FIG. 9 is a graph showing the result obtained by measuring a depth of a concave at the part where the magneto-resistance effect element is created and the rate of omission of signals caused by noises;

FIG. 10 is a diagrammatic view showing the state of reproducing signals recorded in the magnetic tape by the magneto-resistance effect type magnetic head; and

FIG. 11 is a magnified section view of the main part showing one example of the magnetic tape.

### DESCRIPTION OF THE PREFERRED EMBODIMENTS

Preferred embodiments of the invention will be explained below in detail with reference to the drawings.

A magnetic signal reproducing apparatus of the invention uses a magnetic tape as a recording medium and may be used as a video tape recorder, an audio tape recorder, a computer data storage system or the like.

The magnetic signal reproducing apparatus of the invention will be explained below by exemplifying a helical scan type magnetic signal reproducing apparatus which records/reproduces magnetic signals by using a rotary drum.

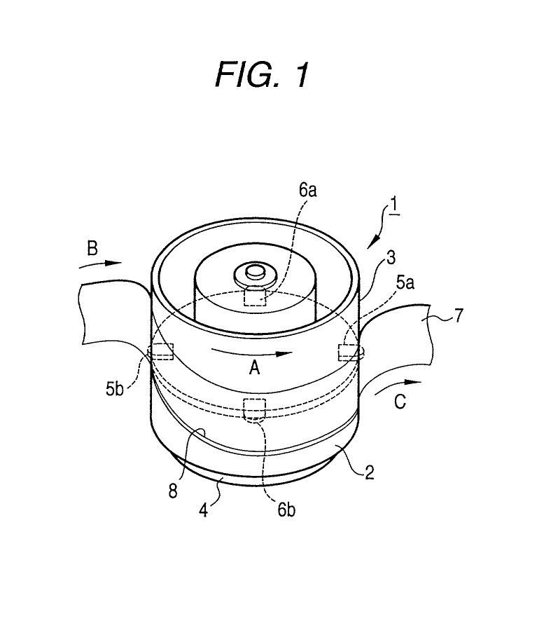

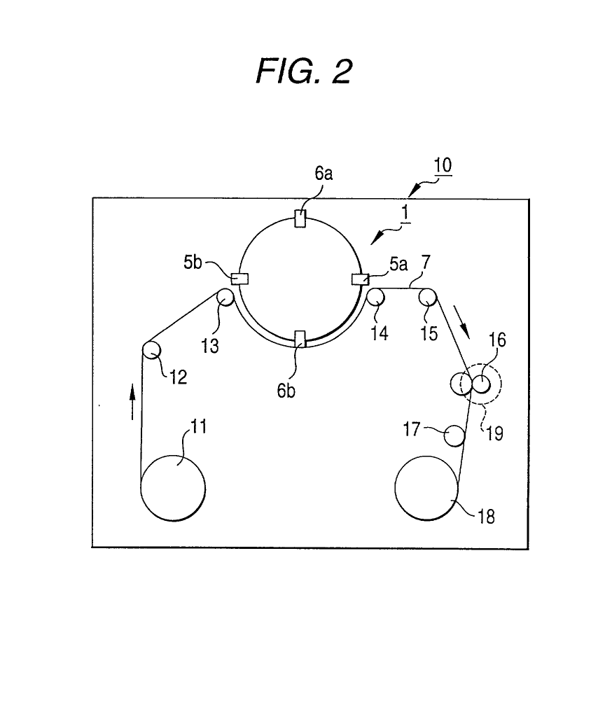

FIGS. 1 and 2 show one structural example of a rotary drum unit mounted in the magnetic signal reproducing apparatus. It is noted that FIG. 1 is a perspective view showing the outline of the rotary drum unit 1 and FIG. 2 is a plan view showing the outline of a magnetic tape feed mechanism 10 including the rotary drum unit 1.

As shown in FIG. 1, the rotary drum unit 1 comprises a cylindrical stationary drum 2, a cylindrical rotary drum 3, a motor 4 for driving and rotating the rotary drum 3, a pair of inductive magnetic heads 5a and 5b and a pair of magneto-resistance effect type magnetic heads 6a and 6b mounted in the rotary drum 3.

The stationary drum 2 is a drum held without rotation. A lead guide section 8 is created on the side of the stationary drum 2 along the traveling direction of a magnetic tape 7. The magnetic tape 7 is run along the lead guide section 8 in recording/reproducing signals as described later. The rotary drum 3 is disposed so that its center axis coincides with that of the stationary drum 2.

The rotary drum 3 is a drum driven and rotated at predetermined rotary speed by the motor 4 in recording/reproducing signals to/from the magnetic tape 7. The rotary drum 3 is formed into the cylindrical shape having almost the equal diameter and the same center axis with the stationary drum 2. The pair of inductive magnetic heads 5a and 5b and the pair of magneto-resistance effect type magnetic heads 6a and 6b are mounted on the sides of the rotary drum 3 facing to the stationary drum 2.

The inductive magnetic heads 5a and 5b are recording magnetic heads in which a pair of magnetic cores are junctioned via a magnetic gap and are wound by coils and are used in recording signals to the magnetic tape 7. These inductive magnetic heads 5a and 5b are mounted in the rotary drum 3 so as to make an angle of 180° from each other with respect to the center of the rotary drum 3 and so that their magnetic gap portion protrudes out of the outer circumference of the rotary drum 3. It is noted that these inductive magnetic heads 5a and 5b are set so that their azimuth angle are opposite from each other so as to implement azimuthal recording.

Meanwhile, the magneto-resistance effect type magnetic heads 6a and 6b are reproducing magnetic heads comprising a magneto-resistance effect element as a magneto-sensitive element for detecting signals recorded in the magnetic tape 7 and are used in reproducing the signals from the magnetic tape 7. It is noted that these magneto-resistance effect type magnetic heads 6a and 6b are magnetic heads to which the invention is applied and hence their structure will be explained later in detail.

These magneto-resistance effect type magnetic heads 6a and 6b are mounted in the rotary drum 3 so as to make an angle of 180° from each other with respect to the center of the rotary drum 3 and so that the magnetic gap portion protrudes out of the outer circumference of the rotary drum 3. It is noted that these magneto-resistance effect type magnetic heads 6a and 6b are set so that their azimuth angle are opposite from each other so as to be able to reproduce the signals azimuthally recorded to the magnetic tape 7.

The magnetic signal reproducing apparatus slides the magnetic tape 7 along such rotary drum unit 1 to record/reproduce signals to/from the magnetic tape 7.

That is, the magnetic tape 7 is fed so as to be wound around the rotary drum unit 1 from a supply reel 11 via guide rollers 12 and 13 as shown in FIG. 2 in recording/reproducing the signals by the rotary drum unit 1. Then, the magnetic tape 7 to/from which the signals have been recorded/reproduced by the rotary drum unit 1 is fed to a take-up roller 18 via guide rollers 14 and 15, a capstan 16 and a guide roller 17. That is, the magnetic tape 7 is fed at predetermined tension and speed by the capstan 16 which is driven and rotated by a capstan motor 19 and is taken up by the take-up roller 18 via the guide roller 17.

At this time, the rotary drum 3 is driven and rotated as indicated by an arrow A in FIG. 1 by the motor 4. Meanwhile, the magnetic tape 7 is fed so as to slide obliquely with respect to the stationary drum 2 and the rotary drum 3 along the lead guide section 8 of the stationary drum 2. That is, the magnetic tape 7 is fed along the lead guide section 8 so as to slide and contact with the stationary drum 2 and the rotary drum 3 from the tape input side as indicated by an arrow B in FIG. 1 and is then fed to the tape output side as indicated by an arrow C in FIG. 1 along the tape traveling direction.

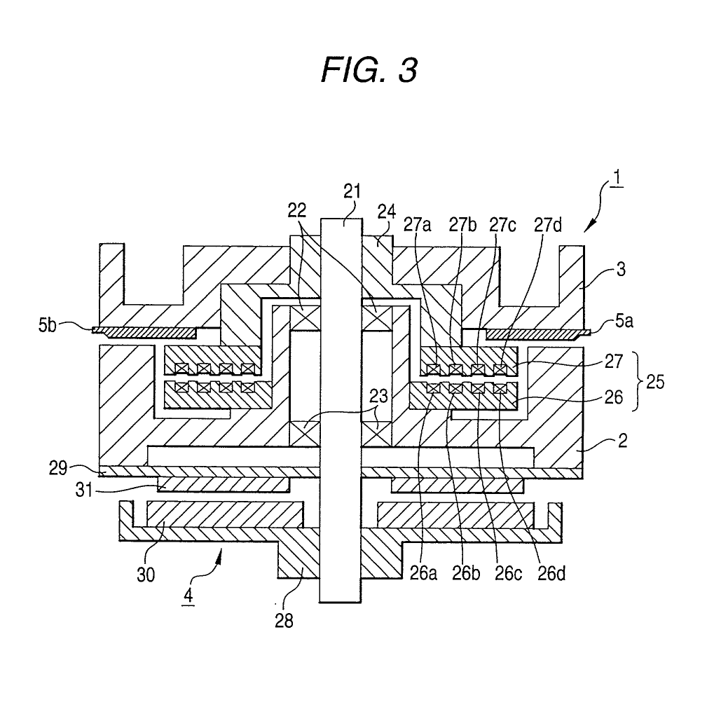

Next, the internal structure of the rotary drum unit 1 will be explained with reference to FIG. 3.

A rotary shaft 21 is inserted through the center of the stationary drum 2 and the rotary drum 3 as shown in FIG. 3. It is noted that the stationary drum 2, the rotary drum 3 and the rotary shaft 21 are made of conductive materials and are electrically conductive. The stationary drum 2 is earthed.

Two bearings 22 and 23 are provided inside of the sleeve of the stationary drum 2 to rotably support the rotary shaft 21 with respect to the stationary drum 2. That is, the rotary shaft 21 is rotably supported by the bearings 22 and 23 with respect to the stationary drum 2. Meanwhile, a flange 24 is created at the inner peripheral portion of the rotary drum 3. The flange 24 is fixed to the upper end portion of the rotary shaft 21, so that the rotary drum 3 rotates as the rotary shaft 21 rotates.

A rotary transformer 25 which is a non-contact signal transmitter is disposed within the rotary drum unit 1 to transmit signals between the stationary drum 2 and the rotary drum 3. The rotary transformer 25 comprises a stator core 26 fixed to the stationary drum 2 and a rotary core 27 fixed to the rotary drum 3.

The stator core 26 and the rotary core 27 are formed into a ring shape centering on the rotary shaft 21 by a magnetic material such as ferrite. In the stator core 26, a pair of signal transmitting rings 26a and 26b corresponding to the pair of inductive magnetic heads 5a and 5b, a signal transmitting ring 26c corresponding to the pair of magneto-resistance effect type magnetic heads 6a and 6b and a power transmitting ring 26d for supplying electric power necessary for driving the pair of magneto-resistance effect type magnetic heads 6a and 6b are disposed concentrically. In the same manner, a pair of signal transmitting rings 27a and 27b corresponding to the pair of inductive magnetic heads 5a and 5b, a signal transmitting ring 27c corresponding to the pair of magneto-resistance effect type magnetic heads 6a and 6b and a power transmitting ring 27d for supplying electric power necessary for driving the pair of magneto-resistance effect type magnetic heads 6a and 6b are disposed concentrically in the rotary core 27.

These rings 26a, 26b, 26c, 26d, 27a, 27b, 27c and 27d are coils wound in a ring centering on the rotary shaft 21 and are disposed so that the respective rings 26a, 26b, 26c and 26d of the stator core 26 face to the respective rings 27a, 27b, 27c and 27d of the rotary core 27. Then, the rotary transformer 25 is arranged so as to transmit signals and power in non-contact between the respective rings 26a, 26b, 26c and 26d of the stator core 26 and the respective rings 27a, 27b, 27c and 27d of the rotary core 27.

The rotary drum unit 1 is also provided with the motor 4 for driving and rotating the rotary drum 3. The motor 4 comprises a rotor 28 which is a rotary part and a stator 29 which is a stationary part. The rotor 28 is fixed to the lower end portion of the rotary shaft 21 and comprises a driving magnet 30. Meanwhile, the stator 29 is fixed to the lower end portion of the stationary drum 2 and comprises a driving coil 31. The rotor 28 is driven and rotated when a current is supplied to the driving coil 31. Thereby, the rotary shaft 21 fixed to the rotor 28 rotates and along that, the rotary drum 3 fixed to the rotary shaft 21 rotates.

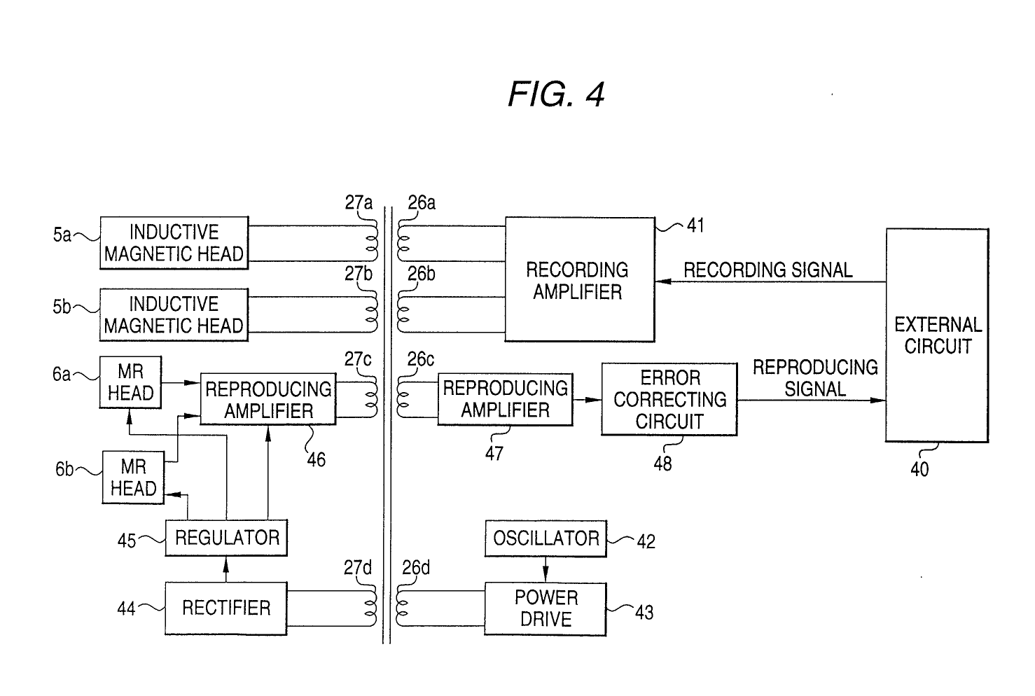

Next, the recording/reproducing operation of the rotary drum unit 1 described above will be explained with reference to FIG. 4 which shows the outline of the circuit structure of the rotary drum unit 1 and its peripheral circuit.

An electric current is supplied to the driving coil 31 of the motor 4 at first in recording signals to the magnetic tape 7 by using the rotary drum unit 1 described above. Thereby, the rotary drum 3 is driven and rotated. Then, recording signals are supplied from an external circuit 40 to a recording amplifier 41 in the state when the rotary drum 3 is rotated as shown in FIG. 4.

A recording amplifier 41 amplifies the recording signal from the external circuit 40 and supplies the recording signal to the signal transmitting ring 26a of the stator core 26 corresponding to the inductive magnetic head 5a at the timing of recording the signal by the inductive magnetic head 5a and to the signal transmitting ring 26b of the stator core 26 corresponding to the inductive magnetic head 5b at the timing of recording the signal by the inductive magnetic head 5b.

Here, the inductive magnetic heads 5a and 5b record the signals alternately with a phase difference of 180° because the inductive magnetic heads 5a and 5b are disposed so as to make the angle of 180° with respect to the center of the rotary drum 3 as described above. That is, the recording amplifier 41 switches the timing of supplying the recording signal to one inductive magnetic head 5a and the timing of supplying the recording signal to the other inductive magnetic head 5b with the phase difference of 180°.

Then, the recording signal supplied to the signal transmitting ring 26a of the stator core 26 corresponding to one inductive magnetic head 5a is transmitted to the signal transmitting ring 27a of the rotary core 27 in non-contact. The recording signal transmitted to the signal transmitting ring 27a of the rotary core 27 is then supplied to the inductive magnetic head 5a which records the signal to the magnetic tape 7.

In the same manner, the recording signal supplied to the signal transmitting ring 26b of the stator core 26 corresponding to the other inductive magnetic head 5b is transmitted to the signal transmitting ring 27b of the rotary core 27 in non-contact. The recording signal transmitted to the signal transmitting ring 27b of the rotary core 27 is then supplied to the inductive magnetic head 5b which records the signal to the magnetic tape 7.

An electric current is supplied to the driving coil 31 of the motor 4 at first to drive and rotate the rotary drum 3 in reproducing the signal from the magnetic tape 7 by using the rotary drum unit 1 described above. Then, a high frequency current is supplied from an oscillator 42 to a power drive 43 in the state when the rotary drum 3 is rotated as shown in FIG. 4.

The high frequency current from the oscillator 42 is converted into a predetermined alternating current by the power drive 43 and is then supplied to the power transmitting ring 26d of the stator core 26. The alternating current supplied to the power transmitting ring 26d of the stator core 26 is transmitted to the power transmitting ring 27d of the rotary core 27 in non-contact. Then, the alternating current transmitted to the power transmitting ring 27d of the rotary core 27 is rectified by a rectifier 44 into a direct current to be supplied to a regulator to be set at predetermined voltage.

The current whose voltage is set at the predetermined voltage by the regulator 45 is supplied to the pair of magneto-resistance effect type magnetic heads 6a and 6b as a sense current. It is noted that the pair of magneto-resistance effect type magnetic heads 6a and 6b are connected with a reproducing amplifier 46 for detecting signals from the magneto-resistance effect type magnetic heads 6a and 6b and the current from the regulator 45 is supplied also to this reproducing amplifier 46.

Here, the magneto-resistance effect type magnetic heads 6a and 6b comprise the magneto-resistance effect element whose resistance value varies depending on the magnitude of the external magnetic field as described later in detail. Then, the magneto-resistance effect type magnetic heads 6a and 6b are arranged such that the resistance value of the magneto-resistance effect element is changed by the signaling magnetic field from the magnetic tape 7 and such that the change of the voltage appears in the sense current.

The reproducing amplifier 46 detects this change of the voltage and outputs a signal corresponding to the change of the voltage as a reproducing signal. It is noted that the reproducing amplifier 46 outputs a reproducing signal detected by the magneto-resistance effect type magnetic head 6a at the timing of reproducing the signal by one magneto-resistance effect type magnetic head 6a and outputs a reproducing signal detected by the magneto-resistance effect type magnetic head 6b at the timing of reproducing the signal by the other magneto-resistance effect type magnetic head 6b.

Because the pair of magneto-resistance effect type magnetic heads 6a and 6b are disposed so as to make the angle of 180° with respect to the center of the rotary drum 3 as described before, these magneto-resistance effect type magnetic heads 6a and 6b reproduce the signals alternately with the phase difference of 180°0. That is, the reproducing amplifier 46 switches the timing of outputting the reproducing signal from the magneto-resistance effect type magnetic head 6a and the timing of outputting the reproducing signal from the magneto-resistance effect type magnetic head 6b with the phase difference of 180°.

Then, the reproducing signals from the reproducing amplifier 46 are supplied to the signal transmitting ring 27c of the rotary core 27 and are transmitted to the signal transmitting ring 26c of the stator core 26 in non-contact. The reproducing signals transmitted to the signal transmitting ring 26c of the stator core 26 are amplified by a reproducing amplifier 47 and are then supplied to an error correcting circuit 48. Then, after implementation of an error correcting process by the error correcting circuit 48, the reproducing signals are outputted to the external circuit 40.

It is noted that when the circuits are structured as shown in FIG. 4, the pair of inductive magnetic heads 5a and 5b, the pair of magneto-resistance effect type magnetic heads 6a and 6b, the rectifier 44, the regulator 45 and the reproducing amplifier 46 are mounted in the rotary drum 3 and rotate together with the rotary drum 3. Meanwhile, the recording amplifier 41, the oscillator 42, the power drive 43, the reproducing amplifier 47 and the error correcting circuit 48 are disposed at the stationary part of the rotary drum unit 1 or are set as external circuits constructed separately from the rotary drum unit 1.

Next, the magneto-resistance effect type magnetic heads 6a and 6b mounted in the rotary drum 3 described above will be explained in detail. It is noted that the magneto-resistance effect type magnetic heads 6a and 6b have the same structure except of that their azimuth angles are set to be opposite from each other. Then, these magneto-resistance effect type magnetic heads 6a and 6b will be called the magneto-resistance effect type magnetic head 6 altogether in the following description.

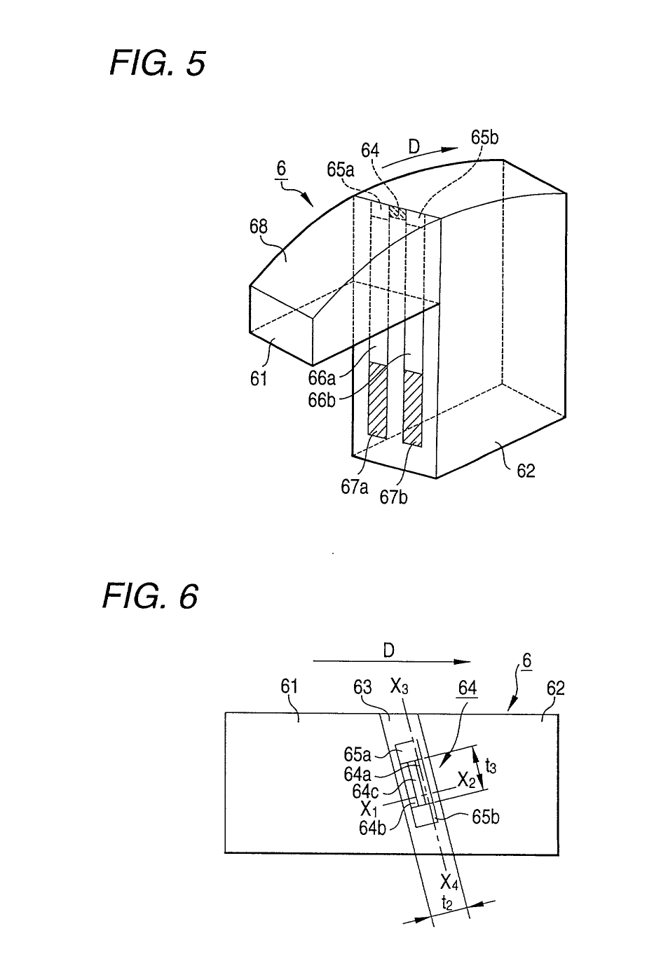

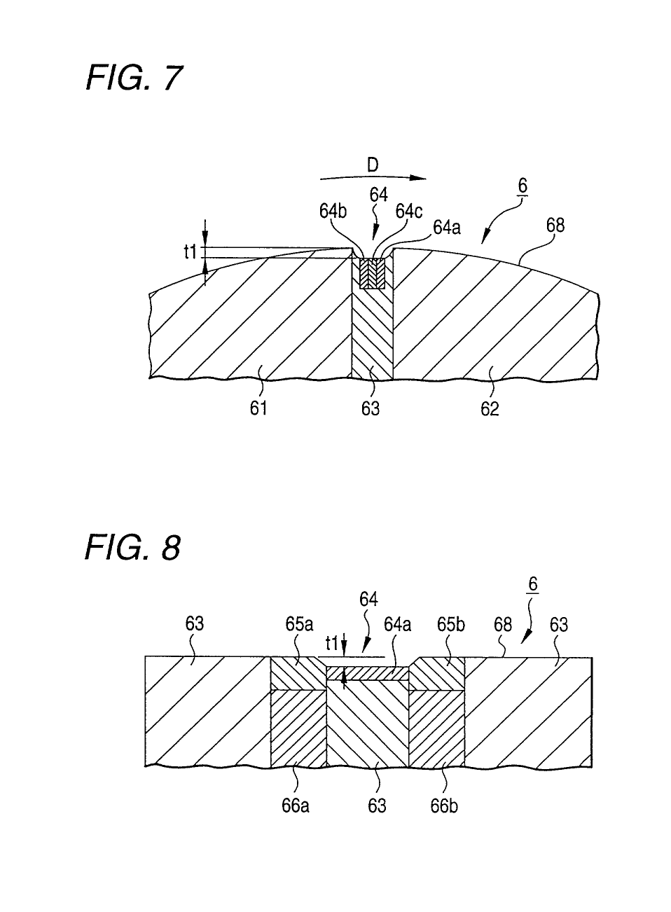

FIG. 5 is a schematic perspective view of the magneto-resistance effect type magnetic head 6 and FIG. 6 is a plan view when the magneto-resistance effect type magnetic head 6 is seen from the side of the magnetic tape sliding face thereof. FIG. 7 is a section view taken along a line X1-X2 in FIG. 6 and FIG. 8 is a section view taken along a line X3-X4 in FIG. 6.

The magneto-resistance effect type magnetic head 6 is a magnetic head only for reproduction which is mounted in the rotary drum 3 and which detects signals recorded in the magnetic tape 7 by utilizing a magneto-resistance effect in a helical scan method. The magneto-resistance effect type magnetic head is suited for high density recording because its sensitivity is high and its reproduced output is large as compared to an inductive magnetic head which records/reproduces signals by utilizing electromagnetic induction in general. Accordingly, the use of the magneto-resistance effect type magnetic head 6 as the reproduction only magnetic head allows signals to be recorded more densely.

As shown in FIGS. 5 and 6, the magneto-resistance effect type magnetic head 6 comprises a pair of magnetic shields 61 and 62 made of a relatively hard soft magnetic material such as Ni—Zn ferrite and Mn—Zn ferrite, a magneto-resistance effect element 64 sandwiched by the pair of magnetic shields 61 and 62 via an insulating layer 63, permanent magnet films 65a and 65b disposed respectively on the both sides of the magneto-resistance effect element 64, and conductors 66a and 66b connected respectively to the permanent magnet films 65a and 65b. It is noted that FIG. 5 shows the head while omitting the insulating layer 63 and FIG. 6 shows the head by magnifying the magneto-resistance effect element 64 and the nearby part thereof.

In the magneto-resistance effect type magnetic head 6, the magneto-resistance effect element 64 is disposed so as to have a predetermined azimuth angle with respect to the sliding direction D of the magneto-resistance effect type magnetic head 6 with respect to the magnetic tape 7 as shown in FIG. 6 and is formed by laminating a magneto-resistance effect film 64a having a magneto-resistance effect, a SAL (Soft Adjacent Layer) film 64b and an insulating film 64c disposed between the magneto-resistance effect film 64a and the SAL film 64b.

The magneto-resistance effect film 64a is made of a soft magnetic material such as Ni—Fe whose resistance value varies depending on the external magnetic field by its anisotropic magneto-resistance effect (AMR). The SAL film 64b is what applies a vertically biased magnetic field to the magneto-resistance effect film 64a by a so-called SAL biasing method and is made of a magnetic material having low coercive force and high permeability. The insulating film 64c insulates the magneto-resistance effect film 64a from the SAL film 64b to prevent electrical diversion loss and is made of Ta having a high resistance phase for example.

The permanent magnet films 65a and 65b are disposed on the both sides of the magneto-resistance effect element 64. The permanent magnet films 65a and 65b apply horizontally biased magnetic field to the magneto-resistance effect element 64 and are disposed on the both sides of the magneto-resistance effect element 64 so as to contact therewith in a so-called abutment structure. These permanent magnet films 65a and 65b are made of a magnetic material having large coercive force and conductivity like Co—Ni—Pt and Co—Cr—Pt.

Further, the conductors 66a and 66b connected respectively to the permanent magnet films 65a and 65b are formed on the side of one magnetic shield 62 so as to expose their ends to the outside as terminals 67a and 67b for supplying the sense current from the outside to the magneto-resistance effect element 64. That is, the sense current is supplied to the magneto-resistance effect element 64 from these terminals 67a and 67b via the conductors 66a and 66b and permanent magnet films 65a and 65b.

In the magneto-resistance effect type magnetic head 6, the magneto-resistance effect element 64 is formed into a rectangular plan shape and is sandwiched by the pair of magnetic shields 61 and 62 via the insulating layer 63 such that the direction of a short axis thereof is approximately vertical to a magnetic tape sliding face 68 and such that one side thereof is exposed to the side of the magnetic tape sliding face 68. Here, the magneto-resistance effect element 64 is sandwiched by a hard material. That is, the pair of magnetic shields 61 and 62 are formed of a material whose hardness is higher than that of the magneto-resistance effect element 64.

Then, in the magneto-resistance effect type magnetic head 6 to which the invention is applied, a part between the pair of magnetic shields 61 and 62 where the magneto-resistance effect element 64 is formed on the magnetic tape sliding face 68 of the magneto-resistance effect type magnetic head 6 is formed to be a concave whose depth t1 is 3 to 30 nm as shown in FIGS. 7 and 8.

A slight gap is created between the magneto-resistance effect element 64 and the magnetic tape 7 even when the magnetic tape 7 is slid along the magneto-resistance effect type magnetic head 6 in reproducing signals recorded in the magnetic tape 7 by forming the part where the magneto-resistance effect element 64 is created into the concave shape. It then enables to avoid contact noises which otherwise occur when the magneto-resistance effect element 64 contacts with the magnetic tape 7.

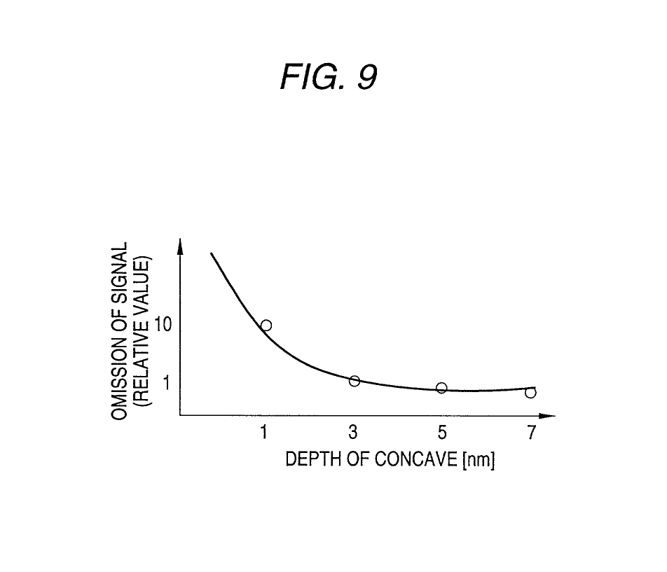

FIG. 9 is a graph showing the result obtained by measuring the depth t1 of the concave at the part where the magneto-resistance effect element 64 is created and the rate of omission of signals caused by such noises. As shown in FIG. 9, the deeper the depth t1 of the concave, the less the rate of the omission of signals caused by noises becomes. It is because it becomes hard for the magneto-resistance effect element 64 to contact with the magnetic tape 7 and the contact noise decreases as the depth t1 of the concave is deepened. However, when the depth t1 of the concave is 3 nm or more, no considerable change can be seen in the rate of omission of signals caused by the noise even if the depth t1 is deepened further. It indicates that almost no contact noise occurs when the depth t1 of the concave is 3 nm or more. Accordingly, it is almost possible to avoid the occurrence of the contact noise by setting the depth t1 of the concave at 3 nm or more.

However, when the depth t1 of the concave is deepened too much, the gap (so-called spacing) between the magneto-resistance effect element 64 and the magnetic tape 7 is widened, thus causing a spacing loss. The spacing loss may be expressed approximately as 54.6×λ/T, where T is the gap between the magneto-resistance effect element 64 and the magnetic tape 7 and λ is a recording wavelength of the magnetic signal recorded in the magnetic tape 7.

Normally, it is desired to suppress the spacing loss to be about 6 dB or less in the magnetic signal reproducing apparatus. It is also desired to keep the shortest recording wavelength of the magnetic signal to be recorded in the magnetic tape 7 to be about 0.4 μm or less to increase the recording density of the magnetic tape 7 by using the magneto-resistance effect type magnetic head 6 in the magnetic signal reproducing apparatus to which the invention is applied.

Then, the depth t1 of the concave is set at 25 nm or less in the magneto-resistance effect type magnetic head 6 described above. It is possible to suppress the spacing loss to about 6 dB or less even if spacing caused by other factors is taken into consideration when the shortest recording wavelength is 0.4 μm by setting the depth t1 of the concave at 25 nm or less.

It is noted that the other factors of the spacing include an influence of an air film created between the magnetic tape and the magnetic head, an influence of the nature of the surface of the magnetic tape, an influence of the nature of the surface of the magnetic head at the magnetic tape sliding face and others. Normally, the spacing of around 25 nm is caused between the magnetic head and the magnetic tape by these influences in the helical scan type magnetic signal reproducing apparatus. Accordingly, when the depth t1 of the concave is set at 25 nm, the total spacing turns out to be about 50 nm.

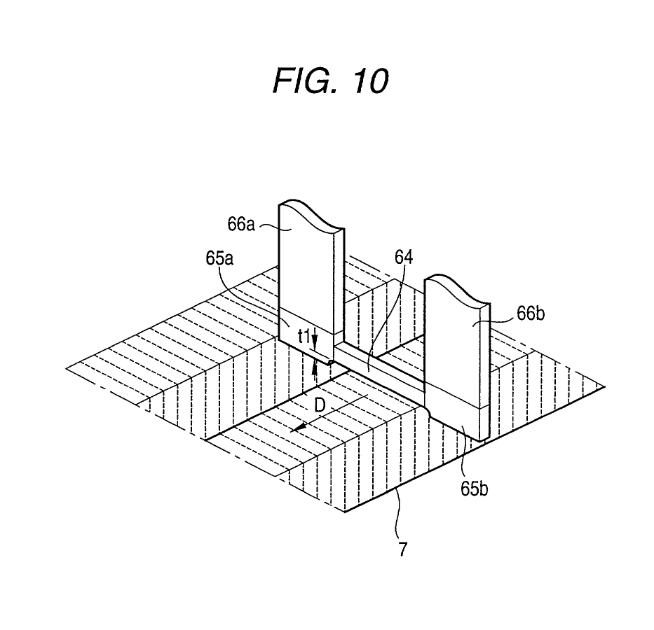

The magnetic tape 7 is slid along the magneto-resistance effect type magnetic head 6 so that the magneto-resistance effect element 64 faces to the magnetic tape 7 as shown in FIG. 10 in reproducing signals recorded in the magnetic tape 7 by using the magneto-resistance effect type magnetic head 6 constructed as described above. It is noted that FIG. 10 is a diagrammatic view showing the state of reproducing the signals by the magneto-resistance effect type magnetic head 6 by magnifying the magnetic tape 7 in which guard-bandless recording has been implemented with the predetermined azimuth angle, the magneto-resistance effect element 64 of the magneto-resistance effect type magnetic head 6 sliding on the magnetic tape 7 and the vicinity thereof. An arrow D in FIG. 10 indicates the direction in which the magneto-resistance effect type magnetic head 6 slides with respect to the magnetic tape 7.

The sense current is supplied to the magneto-resistance effect element 64 via the permanent magnet films 65a and 65b connected to the both ends of the magneto-resistance effect film 64 and the conductors 66a and 66b while sliding the magneto-resistance effect type magnetic head 6 on the magnetic tape 7 so that the magneto-resistance effect element 64 faces to the magnetic tape 7 as shown in FIG. 10 in reproducing the signals recorded in the magnetic tape 7. At this time, the resistance value of the magneto-resistance effect element 64 varies corresponding to the signaling magnetic field from the magnetic tape 7 and the voltage of the sense current varies as a result. Then, the signals recorded in the magnetic tape 7 may be reproduced by detecting the signaling magnetic field from the magnetic tape 7 by detecting the changes of the voltage of the sense current.

It is noted that any element which exhibits the magneto-resistance effect may be used as the magneto-resistance effect element 64 used in the magneto-resistance effect type magnetic head 6 and a so-called giant magneto-resistance effect element (GMR element) which is structured so as to be able to obtain a larger magneto-resistance effect by laminating a plurality of thin films may be also used for example. Further, the method of applying the vertically biased magnetic field to the magneto-resistance effect film 64a needs not to be the SAL biasing method and various methods such as a permanent magnet biasing method, a shunt current biasing method, a self-biasing method, a switching biasing method, a barber pole method, a partial device method and a servo-biasing method may be applied. It is noted that the giant magneto-resistance effect and the various biasing methods are described in detail in “Magneto-Resistance Head, Its Basic and Application” translated by Kazuhiko Hayashi, published by Maruzen Co., Ltd. for example.

The magnetic tape 7 is slid along the magneto-resistance effect type magnetic head 6 in reproducing the signals recorded in the magnetic tape 7. Therefore, the magnetic tape sliding face 68 of the magneto-resistance effect type magnetic head 6 is abraded gradually as signals are reproduced by sliding the magnetic tape 7. Then, the contact noise is liable to occur or the spacing loss increases when the depth t1 of the concave created at the part of the magneto-resistance effect element 64 fluctuates due to this abrasion. Accordingly, it is desirable to keep the depth t1 of the concave constant regardless of the abrasion of the magnetic tape sliding face 68 in the magneto-resistance effect type magnetic head 6.

Then, the width t2 of the concave is set at 400 nm or less and the length t3 of the concave is set at 10 μm or less as shown in FIG. 6. It is noted that the width t2 of the concave corresponds to the distance between a pair of magnetic shields 61 and 62 and the length t3 of the concave corresponds to the length in the longitudinal direction of the magneto-sensitive section of the magneto-resistance effect element 64. The depth t1 of the concave may be kept constant regardless of the abrasion of the magnetic tape sliding face 68 by setting the width t2 and the length t3 of the concave as described above.

In other words, even if the magnetic tape sliding face 68 is abraded as the magnetic tape 7 is slid against the magneto-resistance effect type magnetic head 6, the abrasion loss of the magnetic shields 61 and 62 of the magneto-resistance effect type magnetic head 6 is almost equalized with the abrasion loss of the part of the concave and the depth t1 of the concave is kept almost constant by setting the width t2 of the concave at 400 nm or less and the length t3 thereof at 10 μm or less.

That the part of the concave is also abraded means that the magneto-resistance effect element 64 created in the part of the concave also contacts with the magnetic tape 7 sometimes. Accordingly, contact noises occur more or less when the abrasion loss of the part of the magnetic shields 61 and 62 of the magneto-resistance effect type magnetic head 6 is almost equalized with the abrasion loss of the part of the concave. However, as it is apparent from the measured result shown in FIG. 9, the occurrence of the contact noise is very small even if it occurs by setting the depth t1 of the concave at 3 nm or more.

When signals have been actually reproduced from the magnetic tape 7 by the helical scan method by using the magneto-resistance effect type magnetic head 6 in which the depth t1 of the concave is set at 3 to 25 nm, the width t2 thereof at 400 nm or less and the length t3 thereof at 10 μm or less, the contact noise has occurred in the frequency of about once at most per one inclined track. It is fully possible to correct a signal omitted by the contact noise by an error correcting process if the contact noise occurs in such a degree of occurrence.

Because the magnetic signal reproducing apparatus comprises the error correcting circuit 48 for correcting errors contained in the signals reproduced by the magneto-resistance effect type magnetic head 6, it is fully possible to deal with the contact noises which occur more or less by the error correcting circuit 48.

The degree of abrasion of the magnetic tape sliding face 68 in the magneto-resistance effect type magnetic head 6 also depends on the magnetic tape 7 to be used. Then, the magnetic tape 7 from which the signals are reproduced by the magneto-resistance effect type magnetic head 6 will be explained below in detail.

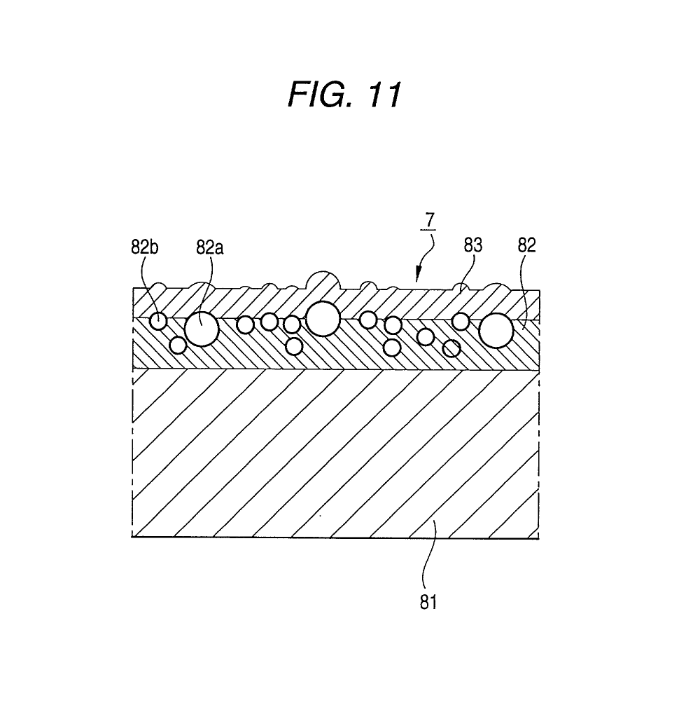

As shown in FIG. 11, the magnetic tape 7 comprises a non-magnetic particle-bearing layer 82 into which non-magnetic particles 82a and 82b are added and which is formed on a tape-like non-magnetic carrier 81 made of a plastic film or the like and a magnetic layer 83 formed on the non-magnetic particle-bearing layer 82.

It is noted that the magnetic tape 7 needs not be composed of only the non-magnetic carrier 81, the non-magnetic particle-bearing layer 82 and the magnetic layer 83. That is, the magnetic layer 83 may be formed after forming an undercoating layer on the non-magnetic carrier 81 and the non-magnetic particle-bearing layer 82, a lubricant layer may be formed on the magnetic layer 83, or a back-coating layer may be formed on the back of the non-magnetic carrier 81.

In the magnetic tape 7 described above, the non-magnetic particle-bearing layer 82 is formed by adding the non-magnetic particles 82a whose diameter is 40 to 200 nm and the non-magnetic particles 82b whose diameter is 10 to 30 nm into a binder resin. Here, the density of the non-magnetic particles 82a whose diameter is 40 to 200 nm is about ten thousand to hundred thousand/mm² and the density of the non-magnetic particles 82b whose diameter is 10 to 30 nm is about three million/mm². It is noted that non-organic particles such as colloidal silica, calcium carbonate, titanium dioxide and alumina are suited for these non-magnetic particles 82a and 82b.

In the magnetic tape 7, the magnetic layer 83 is formed by forming a ferromagnetic metallic material such as Co, Co—Cr, Co—Ni, Co—Fe—Ni or Co—Ni—Cr on the non-magnetic carrier 81 by means of vacuum evaporation, sputtering or ion-plating.

Because the magnetic layer 83 is formed on the non-magnetic particle-bearing layer 82 in which the non-magnetic particles 82a and 82b are added in the magnetic tape 7, a large number of small protrusions are created on the surface thereof. It greatly improves the traveling performance of the magneto-resistance effect type magnetic head 6 when the magneto-resistance effect type magnetic head 6 is run while sliding along the tape.

It is noted that it is possible not to add the non-magnetic particles 82a and 82b into the binder resin as described above but to disperse within the original material of the non-magnetic carrier 81 in advance and to cause to float on the surface of the non-magnetic carrier 81 by coagulating them in producing the non-magnetic carrier 81. Or, it is possible to disperse the non-magnetic particles 82a having the large diameter in the non-magnetic carrier 81 in advance and to form the non-magnetic particle-bearing layer 82 containing only the non-magnetic particles 82b having the smaller diameter on the non-magnetic carrier 81.

Then, the magnetic tape 7 is slid along the magneto-resistance effect type magnetic head 6 as described above in reproducing the signals recorded in the magnetic tape 7. At this time, abrasion occurs on the magnetic tape sliding face 68 of the magneto-resistance effect type magnetic head 6.

At this time, it is possible to arrange such that the part of the magnetic shields 61 and 62 and the part of the concave are abraded respectively when the magnetic tape sliding face 68 of the magneto-resistance effect type magnetic head 6 is abraded by adding the non-magnetic particles 82a having the large diameter and the non-magnetic particles 82b having the smaller diameter respectively at the predetermined density.

It is also possible to almost equalize the abrasion loss of the part of the magnetic shields 61 and 62 with the abrasion loss of the part of the concave by adequately setting the diameters and the density of the non-magnetic particles 82a and 82b. When an experiment was actually carried out, it was confirmed that the abrasion loss of the part of the magnetic shields 61 and 62 is almost equalized with the abrasion loss of the part of the concave and the depth t1 of the concave is kept almost constant even if the magnetic tape sliding face 68 of the magneto-resistance effect type magnetic head 6 is abraded by using the particles of 40 to 200 nm in diameter as the non-magnetic particle 82a having the larger diameter in the density of ten thousand to hundred thousand/mm² and by using the particles of 10 to 30 nm in diameter as the non-magnetic particle 82b having the smaller diameter in the density of three million/m² or more.

Thus, the use of the magnetic tape 7 having the non-magnetic particle-bearing layer 82 in which the non-magnetic particles 82a having the larger diameter and the non-magnetic particle 82b having the smaller diameter are added respectively at the predetermined density and the magnetic layer 83 formed on the non-magnetic particle-bearing layer 82 allows the depth t1 of the concave to be kept almost constant even if abrasion occurs on the magnetic tape sliding face 68 of the magneto-resistance effect type magnetic head 6.

As described above in detail, the inventive magneto-resistance effect type magnetic head causes almost no contact noise even if the magnetic tape is slid and causes only the small spacing loss, thus allowing a fully large reproduced output to be obtained. Accordingly, the invention allows the magneto-resistance effect type magnetic head which is suited for the highly densified recording to be adopted as the reproducing head of the magnetic signal reproducing apparatus in which the magnetic head contacts with the recording medium and allows the recording density of the magnetic tape to be increased further.

While the preferred embodiment has been described, variations thereto will occur to those skilled in the art within the scope of the present inventive concepts which are delineated by the following claims.

What is claimed is:

1. A magneto-resistance effect type magnetic head, comprising:
a magneto-resistance effect element as a magneto-sensitive element for detecting magnetic signals;
a pair of shields sandwiching said magneto-resistance effect element; and
an insulating layer disposed between said magneto-resistance effect element and said pair of shields;
said magneto-resistance effect element, said insulating layer and said pair of shields having a magnetic medium sliding face; and
a part between said pair of shields where said magneto-resistance effect element is created in said magnetic medium sliding face being a concave whose depth is 3 to 30 nm.

2. The magneto-resistance effect type magnetic head according to claim 1, wherein the distance between said pair of shields is 400 nm or less and the length of a magneto-sensitive section of said magneto-resistance effect element in the longitudinal direction is 10 μm or less.

3. The magneto-resistance effect type magnetic head according to claim 1, wherein said pair of shields are made of a material whose hardness is higher than the hardness of said magneto-resistance effect element.

4. A magnetic signal reproducing apparatus having a magneto-resistance effect type magnetic head comprising:
a magneto-resistance effect element as a magneto-sensitive element for detecting magnetic signals;
a pair of shields sandwiching said magneto-resistance effect element; and
an insulating layer disposed between said magneto-resistance effect element and said pair of shields;
said magneto-resistance effect element, said insulating layer and said pair of shields having a magnetic medium sliding face; and
a part between said pair of shields where said magneto-resistance effect element is created in said magnetic medium sliding face being a concave whose depth is 3 to 30 nm.

5. The magnetic signal reproducing apparatus according to claim 4, wherein said magnetic medium is a magnetic tape.

6. The magnetic signal reproducing apparatus according to claim 4, wherein the distance between said pair of shields is 400 nm or less and the length of a magneto-sensitive section of said magneto-resistance effect element in the longitudinal direction is 10 μm or less.

7. The magnetic signal reproducing apparatus according to claim 4, wherein said pair of shields are made of a material whose hardness is higher than the hardness of said magneto-resistance effect element.

8. The magnetic signal reproducing apparatus according to claim 5, wherein a magnetic tape comprising a non-magnetic particle-bearing layer in which non-magnetic particles having larger diameter and non-magnetic particles having smaller diameter are added in the predetermined density and a magnetic layer formed on said non-magnetic particle-bearing layer is used.

9. The magnetic signal reproducing apparatus according to claim 5, wherein the shortest recording wavelength of a magnetic signal recorded in said magnetic tape is 0.4 μm or less.

10. The magnetic signal reproducing apparatus according to claim 4, further comprising error correcting means for correcting errors contained in the signal reproduced by said magneto-resistance effect type magnetic head.

11. The magnetic signal reproducing apparatus according to claim 5, wherein said magneto-resistance effect type magnetic heads are mounted in a rotary drum and reproduce the signal from the magnetic tape by means of helical scan method.
